(19) United States
(12) Patent Application Publication
(10) Pub. No.: US 2026/0288281 A1
(43) Pub. Date: Sep. 24, 2026

(54) NOISE CANCELING SYSTEM AND TOUCH DISPLAY DEVICE

(71) Applicant: NOVATEK Microelectronics Corp., Hsinchu (TW)

(72) Inventors: Yu-Ying TANG, Taoyuan City (TW); Ting-Yu CHAN, Hsinchu City (TW); I-Te LIU, Hsinchu County (TW); Chih-Wei KU, New Taipei City (TW); Chih-Chang LAI, Taichung City (TW)

(21) Appl. No.: 19/286,231

(22) Filed: Jul. 30, 2025

(30) Foreign Application Priority Data
Mar. 21, 2025 (TW) 114110814

(51) Int. Cl. G06F 3/041

(52) U.S. Cl. CPC G06F 3/04182; G06F 3/04164

(57) ABSTRACT

A noise canceling system comprising multiple signal receiving lines, a touch display chip and multiple noise canceling circuits is provided. The signal receiving lines are configured according to a layout design, and are configured to generate multiple touch signals. The signal receiving lines are classified into multiple line groups according to the layout design. The touch display chip is coupled to a portion of the signal receiving lines and configured to receive the touch signals of the portion and multiple noise canceling signals to generate multiple adjusted touch signals. The noise canceling circuits are coupled to the touch display chip and configured to generate the noise canceling signals to the touch display chip based on the touch signals of the signal receiving lines of the line groups. The number of the noise canceling circuits is greater than or equal to the number of the line groups.

### RELATED APPLICATIONS

This application claims priority to Taiwan Application Serial Number 114110814, filed on Mar. 21, 2025, which is herein incorporated by reference in its entirety.

### BACKGROUND

### Technical Field

The present disclosure relates to a technology for canceling noise in a touch display device. More particularly, the present disclosure relates to a noise canceling system and a touch display device for canceling noise by grouping signal receiving lines.

### Description of Related Art

In recent years, with the popularization of smart devices, more and more technological products have begun to use touch screens for operation. For touch screens, noises may cause the touch screen to interpret incorrect operations. If the noises cannot be effectively canceled, they will affect the operation of the touch screen. Therefore, noise processing capability is one of the indicators that determine the performance of the touch screen.

### SUMMARY

A noise canceling system is provided in the present disclosure. The noise canceling system comprises a plurality of signal receiving lines, a plurality of noise canceling circuits and a first touch display chip. The plurality of signal receiving lines are configured to receive a plurality of touch signals from a touch display panel, wherein the plurality of signal receiving lines are classified into a plurality of line groups according to a layout design. The plurality of noise canceling circuits are coupled to the plurality of line groups, and each of the plurality of noise canceling circuits is configured to generate a corresponding noise canceling signal based on the plurality of touch signals received by each of the plurality of line groups. The first touch display chip is configured to receive the plurality of touch signals and the plurality of corresponding noise canceling signals of each of the plurality of line groups, so as to generate a plurality of adjusted touch signals. The number of the plurality of noise canceling circuits is greater than or equal to the number of the plurality of line groups.

A touch display device is provided in the present disclosure. The touch display device comprises a touch display panel, a plurality of signal receiving lines, a plurality of noise canceling circuits and a first touch display chip. The touch display panel comprises a plurality of touch units and a plurality of display units, wherein the plurality of touch units have a touch state, and the plurality of display units are configured to generate a display based on a display signal. The plurality of signal receiving lines are configured to receive a plurality of touch signals from the touch display panel, wherein the plurality of signal receiving lines are classified into a plurality of line groups according to a layout design. The plurality of noise canceling circuits are coupled to the plurality of line groups and respectively configured to generate a corresponding noise canceling signal based on the plurality of touch signals received by each of the plurality of line groups. The first touch display chip is configured to receive the plurality of touch signals and the plurality of corresponding noise canceling signals from each of the plurality of line groups, so as to generate a plurality of adjusted touch signals. The number of the plurality of noise canceling circuits is greater than or equal to the number of the plurality of line groups.

With the noise canceling system and the touch display device disclosed in the present document, various noises can be cancelled in different degrees by classifying circuit components, thereby overcoming the influence of layout design on noise cancellation and improving the performance of noise cancellation.

### BRIEF DESCRIPTION OF THE DRAWINGS

The present disclosure can be more fully understood by reading the following detailed description of the embodiment, with reference made to the accompanying drawings as follows.

FIG. 1 is a functional block diagram of a touch display device in accordance with some embodiments of the present disclosure.

FIG. 2A is a schematic diagram of a touch operation in accordance with some embodiments of the present disclosure.

FIG. 2B is a timing diagram of transmission signals in accordance with some embodiments of the present disclosure.

FIG. 3A is a schematic diagram of a noise canceling system in accordance with some embodiments of the present disclosure.

FIG. 3B is a schematic diagram of a noise canceling system in accordance with some embodiments of the present disclosure.

FIG. 3C is a schematic diagram of a noise canceling system in accordance with some embodiments of the present disclosure.

FIG. 3D is a schematic diagram of a noise canceling system in accordance with some embodiments of the present disclosure.

### DETAILED DESCRIPTION

For the purposes of explanation, numerous specific details are described below in order to provide a thorough understanding of the embodiments of the present disclosure. However, it is evident that one or more embodiments may be practiced without these specific details. In other instances, well-known structures and devices are shown schematically only to simplify the drawings. Reference will now be made in detail to the present embodiments of the disclosure, examples of which are illustrated in the accompanying drawings. Wherever possible, the same reference numbers are used in the drawings and the description to refer to the same or like parts.

In the present disclosure, when an element is referred to as “connected”, it may mean “electrically connected” or “signal connected”. When an element is referred to as “coupled”, it may mean “electrically coupled” or “signal coupled”. “Connected” or “coupled” can also be used to indicate that two or more components operate or interact with each other. As used in the present disclosure, the singular forms “a”, “one” and “the” are also intended to include plural forms, unless the context clearly indicates otherwise. It will be further understood that when used in this specification, the terms “comprises (comprising)” and/or “includes (including)” designate the existence of stated features, regions, integers, steps, operations, elements and/or components, but the existence or addition of one or more other features, regions, integers, steps, operations, elements, components, and/or groups thereof are not excluded.

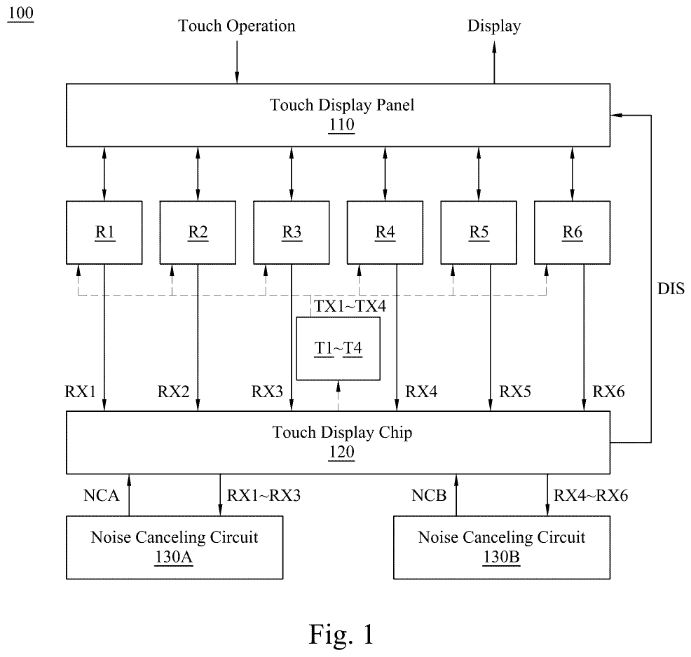

FIG. 1 is a functional block diagram of a touch display device 100 in accordance with some embodiments of the present disclosure. In some embodiments, the touch display device 100 comprises a touch display panel 110, a touch display chip 120, noise canceling circuits 130A, 130B, signal receiving lines R1-R6 and signal transmitting lines T1-T4. In some embodiments, a combination of the touch display chip 120, the noise canceling circuits 130A, 130B, the signal receiving lines R1-R6 and the signal transmitting lines T1-T4 may also be referred to as a “noise canceling system”, which is configured to reduce the signal intensity of noises on the touch display panel 110.

The touch display panel 110 comprises a plurality of touch units and a plurality of display units (not shown). In some embodiments, the touch units of the touch display panel 110 are coupled to the signal receiving lines R1-R6 to receive touch operations (e.g., through physical objects such as fingers and styluses), so that the signal receiving lines R1-R6 receive corresponding touch signals.

In some embodiments, each of the touch units may be implemented with a capacitor, a resistor, other electronic components having the function of changing parameters based on a touch operation, or any combination thereof. For example, a touch unit may comprise a capacitor. Therefore, when the touch unit receives a touch operation, the capacitance of the capacitor will change, thereby causing the signal receiving lines R1-R6 to receive the corresponding touch signals.

In some embodiments, the display units of the touch display panel 110 are coupled to the touch display chip 120, and are configured to generate a corresponding display based on a display signal DIS. Those skilled in the art should be able to understand the technical content of a display unit generating a display based on a display signal, and for the sake of brevity, it will not be repeated here.

The signal receiving lines R1-R6 are coupled to the touch display panel 110, the signal transmitting lines T1-T4 and the touch display chip 120, and are configured to transmit the received touch signals RX1-RX6 to the touch display chip 120 according to a touch state of the touch units of the touch display panel 110 (e.g., whether there is touch, touch strength, etc.). In some embodiments, the signal receiving lines R1-R6 are configured according to a layout design, which may include but is not limited to positions where the signal receiving lines R1-R6 are connected to the touch display chip 120, routing lengths of the signal receiving lines R1-R6, layout locations of the signal receiving lines R1-R6 in the touch display device 100, etc. According to this layout design, the signal receiving lines R1-R6 can be classified into a plurality of line groups for noise processing (which will be described in detail in the following paragraphs).

The signal transmitting lines T1-T4 are coupled to the touch display chip 120 and the signal receiving lines R1-R6. In some embodiments, the signal transmitting lines T1-T4 are configured to assist the touch display chip 120 in transmitting transmission signals TX1-TX4 to the signal receiving lines R1-R6, so as to control the signal receiving lines R1-R6 to sense the touch state of the display units of the touch display panel 110 at different time periods, and transmit the corresponding touch signals RX1-RX6 to the touch display chip 120. The connection relationship and operation method between the signal transmitting lines T1-T4 and the signal receiving lines R1-R6 will be described in detail in the following paragraphs.

The touch display chip 120 is coupled to the touch display panel 110, the noise canceling circuits 130A, 130B, the signal receiving lines R1-R6 and the signal transmitting lines T1-T4, and is configured to generate the display signal DIS to the touch display panel 110, receive multiple signals from the signal receiving lines R1-R6 and the noise canceling circuits 130A, 130B, and then perform noise cancellation operations based on these signals.

Specifically, first, the touch display chip 120 transmits the transmission signals TX1-TX4 to the signal transmitting lines T1-T4 to control the signal receiving lines R1-R6 to transmit the touch signals RX1-RX6 to the touch display chip 120. Next, the touch display chip 120 transmits the touch signals RX1-RX6 to the noise canceling circuits 130A and 130B, so that the noise canceling circuits 130A and 130B generate noise canceling signals NCA and NCB to the touch display chip 120 based on the touch signals RX1-RX6. Finally, the touch display chip 120 generates an adjusted touch signal to the touch display chip 120 based on the received touch signals RX1-RX6 and the noise canceling signals NCA and NCB. In some embodiments, the touch display chip 120 may adjust the original display signal DIS based on the adjusted touch signal, so that the touch display panel 110 can change the display based on the touch operation.

The noise canceling circuits 130A and 130B are coupled to the touch display chip 120, and are configured to generate the corresponding noise canceling signals NCA and NCB based on the received touch signals RX1-RX6, and transmit the noise canceling signals NCA and NCB to the touch display chip 120.

For example, in the embodiment of FIG. 1, the signal receiving lines R1-R6 are classified into two line groups comprising signal receiving lines R1-R3 and signal receiving lines R4-R6, respectively, wherein the noise canceling circuit 130A is configured to receive the touch signals RX1-RX3 of one line group and generate the corresponding noise canceling signal NCA to the touch display chip 120, and the noise canceling circuit 130B is configured to receive the touch signals RX4-RX6 of the other line group and generate the corresponding noise canceling signal NCB to the touch display chip 120.

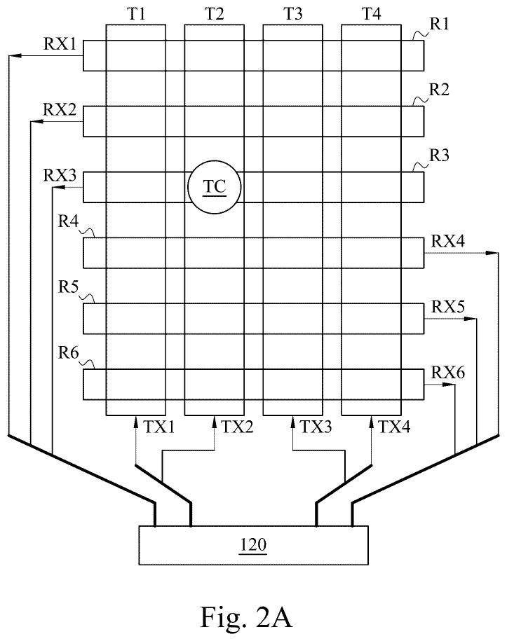

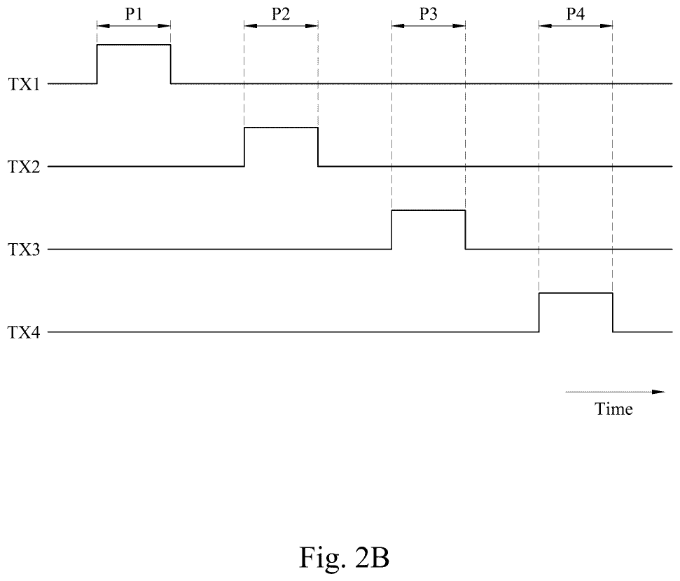

FIG. 2A is a schematic diagram of a touch operation in accordance with some embodiments of the present disclosure. In some embodiments, each of the signal transmitting lines T1-T4 is connected to the signal receiving lines R1-R6, so as to transmit the transmission signals TX1-TX4 to the signal receiving lines R1-R6 respectively, thereby enabling the signal receiving lines R1-R6 to transmit the touch signals RX1-RX6 to the touch display chip 120 at different time periods.

Please refer to FIG. 2A and FIG. 2B together. FIG. 2B is a timing diagram of the transmission signals TX1-TX4 in accordance with some embodiments of the present disclosure. In some embodiments, each of the transmission signals TX1-TX4 has a low level state (e.g., logic 0) and a high level state (e.g., logic 1). When one of the transmission signals TX1-TX4 is switched to the high level state during a specific period, the signal receiving lines R1-R6 transmit the touch signals RX1-RX6 to the touch display chip 120 during this period.

Taking the embodiment of FIG. 2B as an example, the transmission signals TX1-TX4 are switched to the high level state in sequence in time periods P1-P4 respectively, so the signal receiving lines R1-R6 transmit the touch signals RX1-RX6 to the touch display chip 120 once in time periods P1, P2, P3 and P4 respectively, according to the touch state of the touch units.

In some embodiments, each of the touch signals has a signal intensity, wherein the signal intensity can be represented by a voltage value, a current value, other related parameters or any combination thereof. In some embodiments, when a touch unit receives a touch operation, the intensity of the touch signal transmitted by the signal receiving line corresponding to the touch unit will be greater than the intensities of the touch signals transmitted by other signal receiving lines.

Taking the embodiment of FIG. 2A as an example, the signal intensities of the touch signals RX1-RX6 in the time periods P1-P4 are shown in Table 1 below:

TABLE 1

| | |
|---|---|
| Signal intensity | Time period |

| | | | | |
|---|---|---|---|---|
| (mV) | P1 | P2 | P3 | P4 |

| | | | | | |
|---|---|---|---|---|---|
| Touch signal | RX1 | −10 | −15 | 9 | −18 |
| | RX2 | −6 | 7 | 17 | 3 |
| | RX3 | 7 | 104 | 13 | −12 |
| | RX4 | −10 | −7 | −29 | 21 |
| | RX5 | −12 | −24 | −23 | −10 |
| | RX6 | −8 | −17 | 10 | 25 |

In the embodiment of FIG. 2A, the position of a touch point TC corresponds to the signal receiving line R3 and the signal transmitting line T2. In other words, the touch unit connected to the signal receiving line R3 receives a touch operation during the period P2. Therefore, the signal intensity of the touch signal RX3 during the period P2 is significantly greater than the signal intensities of the other touch signals.

In some embodiments, when the signal intensity of a touch signal is greater than or equal to a trigger threshold set by the system, the corresponding touch unit will be determined to have sensed a touch operation. On the contrary, when the signal intensity of the touch signal is less than the trigger threshold, the touch signal will be regarded as a noise for subsequent calculation of the noise canceling signal.

Continuing with the embodiment of Table 1 above, Table 2 below shows the changes in the average values and standard deviations of the noises before and after the noise cancellation operation according to the prior art.

TABLE 2

| | |
|---|---|
| Signal intensity | Time period |

| | | | | |
|---|---|---|---|---|
| (mV) | P1 | P2 | P3 | P4 |

Before noise cancellation operation

| | | | | |
|---|---|---|---|---|
| Average value of noise | −6.5 | −11.2 | −0.5 | 1.5 |
| Standard deviation of noise | 6.32 | 10.59 | 18.29 | 16.48 |

After noise cancellation operation

| | | | | |
|---|---|---|---|---|
| Average value of noise | 0.5 | −0.2 | 0.5 | −0.5 |
| Standard deviation of noise | 6.32 | 10.59 | 18.29 | 16.48 |

In some examples, the signal intensity of a noise canceling signal is determined by the average signal intensity of all noises in the same time period, and the adjusted touch signals are generated by subtracting the signal intensity of the noise canceling signal from the signal intensities of all touch signals. However, as shown in Table 2, since all touch signals are adjusted with the same extent (i.e., the same noise canceling signal is subtracted), although the average values of the signal intensities of the noises are reduced, the standard deviations of the signal intensities of the noises keep the same. Therefore, there is still a significant difference between the noises after the noise cancellation operation of the prior art. Due to the difference in the layout design of the circuit components, a portion of the signal receiving lines will still have strong noise.

As mentioned above, in the touch display device 100 of the present disclosure, the signal receiving lines R1-R6 are classified into a first line group comprising the signal receiving lines R1-R3 and a second line group comprising the signal receiving lines R4-R6, and the noise canceling circuits 130A and 130B are configured to respectively calculate the average signal intensities of the noises of these two line groups, so as to generate corresponding noise canceling signals NCA and NCB.

Continuing with the embodiment of Table 1 above, Table 3 below shows the changes in the average values and standard deviations of the noises before and after the noise cancellation operation is performed on the touch display device 100 proposed in the present disclosure.

TABLE 3

| Signal intensity | Time period | | | |
|---|---|---|---|---|
| (mV) | P1 | P2 | P3 | P4 |

Before noise cancellation operation

| | | | | |
|---|---|---|---|---|
| Average value of the noise of | −3 | −4 | 13 | −9 |
| the first line group | | | | |
| Average value of the noise of | −10 | −16 | −14 | 12 |
| the second line group | | | | |
| Standard deviation of noise | 6.32 | 10.59 | 18.29 | 16.48 |

After noise cancellation operation

| | | | | |
|---|---|---|---|---|
| Average value of the noise of | 0 | 0 | 0 | 0 |
| the first line group | | | | |
| Average value of the noise of | 0 | 0 | 0 | 0 |
| the second line group | | | | |
| Standard deviation of noise | 5.26 | 8.81 | 12.34 | 12.7 |

It can be seen from Table 3 that after the noise cancellation operation, the average values and standard deviations of the noises are reduced. In other words, the difference in noise intensities due to the difference in layout design of circuit components is reduced.

It should be noted that the numbers and classification of the signal receiving lines, signal transmitting lines, line groups and noise canceling circuits in FIG. 1 and FIG. 2A are only examples, and are not intended to limit the present disclosure. In some embodiments, each of the line groups corresponds to a noise canceling circuit, so the number of noise canceling circuits is greater than or equal to the number of line groups. In some other embodiments, one noise canceling circuit may correspond to more than one line group, so the number of noise canceling circuits is less than the number of line groups.

Furthermore, in some embodiments, in order to maintain objectivity when calculating the noise canceling signal, each of the line groups comprises at least two signal receiving lines, so as to ensure that the noise canceling signal is calculated based on at least two noises.

In conclusion, other numbers and other classifications of signal receiving lines, signal transmitting lines, line groups and noise canceling circuits are all within the scope of the present disclosure.

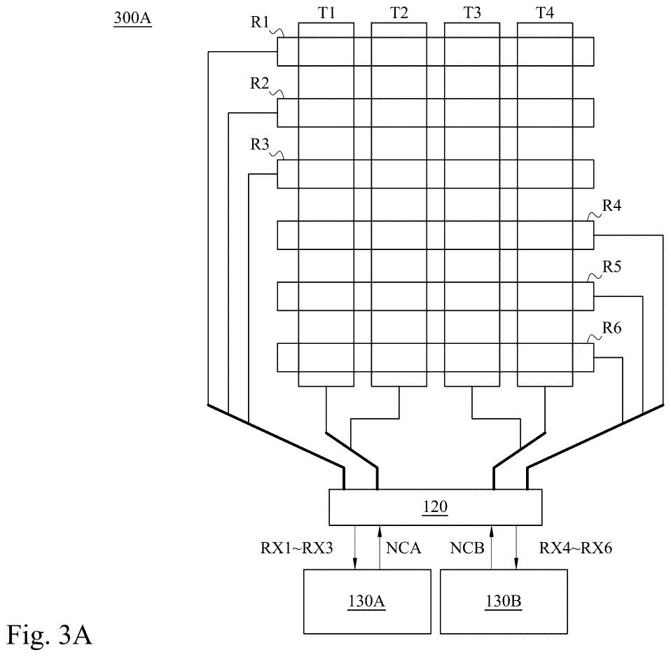

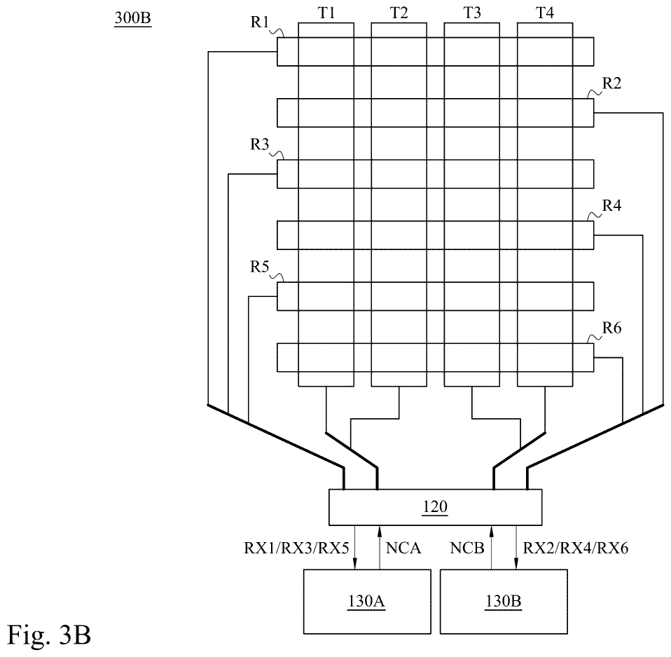

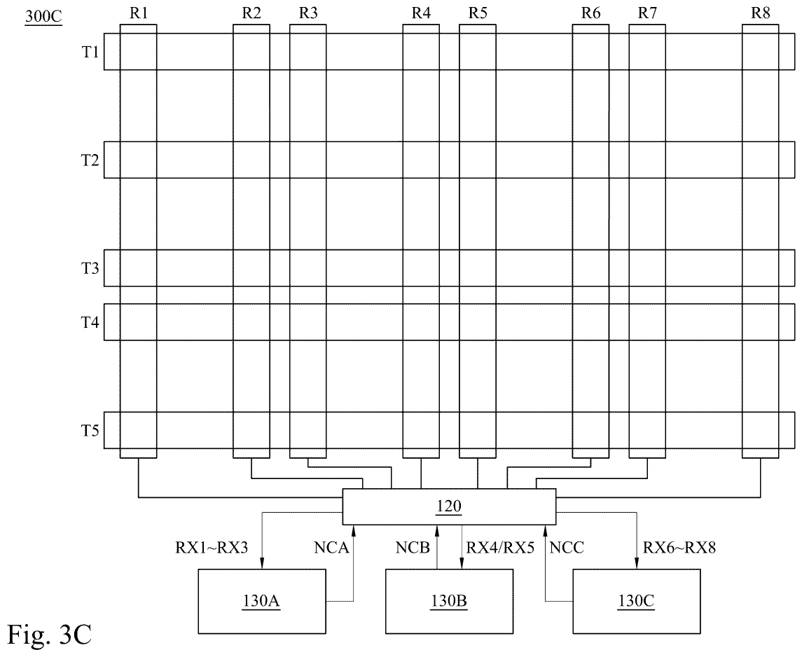

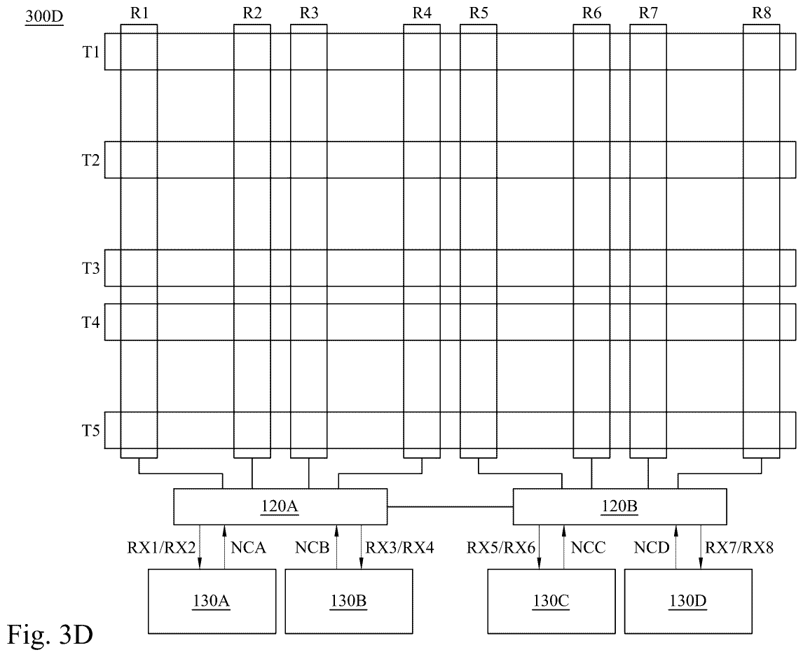

As mentioned above, the signal receiving lines in the noise canceling system can be classified into a plurality of line groups according to the layout design. In some embodiments, the layout design is related to layout locations of the signal receiving lines. FIG. 3A is a schematic diagram of a noise canceling system 300A in accordance with some embodiments of the present disclosure. In the embodiment of FIG. 3A, the signal receiving lines R1-R6 in the noise canceling system 300A are classified into two line groups according to their layout locations. Specifically, the signal receiving lines R1-R3 are classified into one line group because they are located in the upper portion of the noise canceling system 300A, and the noise canceling circuit 130A receives the touch signals RX1-RX3 and generates the corresponding noise canceling signal NCA; the signal receiving lines R4-R6 are classified into another line group because they are located in the lower portion of the noise canceling system 300A, and the noise canceling circuit 130B receives the touch signals RX4-RX6 and generates the corresponding noise canceling signal NCB.

In some embodiments, the aforementioned layout design is related to a routing pattern of the signal receiving lines. FIG. 3B is a schematic diagram of a noise canceling system 300B in accordance with another embodiment of the present disclosure. In the embodiment of FIG. 3B, the signal receiving lines R1-R6 in the noise canceling system 300B are classified into two line groups according to their positions connected to the touch display chip 120. Specifically, the signal receiving lines R1, R3 and R5 are classified into one line group because they are connected to the left side of the touch display chip 120, and the noise canceling circuit 130A receives the touch signals RX1, RX3, RX5 and generates the corresponding noise canceling signal NCA; the signal receiving lines R2, R4 and R6 are classified into another line group because they are connected to the right side of the touch display chip 120, and the noise canceling circuit 130B receives the touch signals RX2, RX4, RX6 and generates the corresponding noise canceling signal NCB.

In some embodiments, the signal receiving lines in the touch display device 100 may be classified into three or more line groups and correspond to three or more noise canceling circuits. Furthermore, in some embodiments, the aforementioned layout design is related to routing lengths of the signal receiving lines. FIG. 3C is a schematic diagram of a noise canceling system 3000 in accordance with yet another embodiment of the present disclosure. In the embodiment of FIG. 3C, the signal receiving lines R1-R8 in the noise canceling system 3000 are classified into three line groups according to the layout locations and routing lengths. Specifically, the signal receiving lines R1-R3 are classified into one line group because they are located in the left portion of the noise canceling system 3000 and have longer routing lengths, and the noise canceling circuit 130A receives the touch signals RX1-RX3 and generates the corresponding noise canceling signal NCA; the signal receiving lines R4, R5 are classified into another line group because they are located in the middle portion of the noise canceling system 3000 and have shorter routing lengths, and the noise canceling circuit 130B receives the touch signals RX4, RX5 and generates the corresponding noise canceling signal NCB; the signal receiving lines R6-R8 are classified into yet another line group because they are located in the right portion of the noise canceling system 3000 and have longer routing lengths, and the noise canceling circuit 130C receives the touch signals RX6-RX8 and generates the corresponding noise canceling signal NCC.

In addition, as mentioned above, in some embodiments not shown, the number of the noise canceling circuits may be smaller than the number of the line groups. For example, the noise canceling system 3000 in FIG. 3C may not comprise the noise canceling circuit 130C (i.e., comprise only two noise canceling circuits). At this time, the noise canceling circuit 130A is not only connected to the line group in the left portion of the noise canceling system 3000 (signal receiving lines R1-R3), but also connected to the line group in the right portion of the noise canceling system 3000 (signal receiving lines R6-R8), so as to generate the noise canceling signal.

It should be noted that the numbers of the touch display chips in FIG. 1, FIG. 2A and FIGS. 3A-3C are only examples, and are not intended to limit the present disclosure. Noise canceling systems with other numbers of touch display chips are within the scope of the present disclosure. In some embodiments, the touch display device 100 may comprise more than two touch display chips.

FIG. 3D is a schematic diagram of a noise canceling system 300D in accordance with yet another embodiment of the present disclosure. In the embodiment of FIG. 3D, the noise canceling system 300D comprises touch display chips 120A and 120B, wherein the touch display chip 120A is connected to the signal receiving lines R1-R4, and the touch display chip 120B is connected to the signal receiving lines R5-R8. In other words, the touch display chip 120A is connected to a first portion of the signal receiving lines R1-R8 (e.g., the signal receiving lines R1-R4), and the touch display chip 120B is connected to a second portion of the signal receiving lines R1-R8 (different from the first portion, e.g., the signal receiving lines R5-R8), so as to process the noises in the signal receiving lines R1-R8 respectively.

In addition, similar to the embodiments of FIG. 3A and FIG. 3B, in the embodiment of FIG. 3D, the touch display chips 120A and 120B are respectively coupled to two noise canceling circuits, and these two noise canceling circuits are respectively configured to calculate noise canceling signals corresponding to at least two line groups.

Specifically, the touch display chip 120A is coupled to the noise canceling circuits 130A and 130B, wherein the noise canceling circuit 130A is configured to generate the noise canceling signal NCA for one line group (signal receiving lines R1 and R2) among the signal receiving lines R1-R4, and the noise canceling circuit 130B is configured to generate the noise canceling signal NCB for another line group (signal receiving lines R3 and R4) among the signal receiving lines R1-R4; the touch display chip 120B is coupled to the noise canceling circuits 130C and 130D, wherein the noise canceling circuit 130C is configured to generate the noise canceling signal NCC for one line group (signal receiving lines R5 and R6) among the signal receiving lines R5-R8, and the noise canceling circuit 130D is configured to generate the noise canceling signal NCD for another line group (signal receiving lines R7 and R8) among the signal receiving lines R5-R8.

In some embodiments, the touch display chips 120A and 120B are connected to each other, so as to synchronously control the signal receiving lines R1-R8 to generate touch signals RX1-RX8 through the signal transmitting lines T1-T5 in multiple time periods (e.g., time periods respectively corresponding to the signal transmitting lines T1-T5).

In some embodiments, the touch display chip (e.g., the touch display chip 120, 120A, 120B) is further configured to store a matching table. The matching table is configured to store a correspondence between the layout design of the signal receiving lines and a configuration method for classifying multiple signal receiving lines into multiple line groups. In operation, when the touch display chip receives a layout design for signal receiving lines (e.g., configured according to the layout designs of FIGS. 3A-3D), the touch display chip will determine the configuration of corresponding line groups according to the matching table. In this way, the touch display chip disclosed in the present disclosure can be applied to various touch display devices with various layout designs.

With the noise canceling system and touch display device disclosed in the present document, multiple signal receiving lines can be classified according to various characteristics of the signal receiving lines, thereby canceling the noises in different degrees. This noise cancellation method can not only reduce the influence of layout design on the effect of noise cancellation, but also improve the flexibility when applied to various touch display screens.

The above are preferred embodiments of the present disclosure. It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims and their equivalents.

What is claimed is:

1. A noise canceling system, comprising:
a plurality of signal receiving lines, configured to receive a plurality of touch signals from a touch display panel, wherein the plurality of signal receiving lines are classified into a plurality of line groups according to a layout design;
a plurality of noise canceling circuits, coupled to the plurality of line groups, and each of the plurality of noise canceling circuits is configured to generate a corresponding noise canceling signal based on the plurality of touch signals received by each of the plurality of line groups; and
a first touch display chip, configured to receive the plurality of touch signals and the plurality of corresponding noise canceling signals of each of the plurality of line groups, so as to generate a plurality of adjusted touch signals, wherein the number of the plurality of noise canceling circuits is greater than or equal to the number of the plurality of line groups.

2. The noise canceling system of claim 1, wherein each of the plurality of touch signals has a signal intensity, and
wherein when the signal intensity of one of the plurality of touch signals is less than a trigger threshold, the one of the plurality of touch signals is configured to be a noise.

3. The noise canceling system of claim 2, wherein each of the plurality of noise canceling circuits is configured to calculate an average value of the signal intensities of the noises in a corresponding one of the plurality of line groups, and configured to generate the plurality of noise canceling signals based on the average value.

4. The noise canceling system of claim 1, wherein the layout design is related to a plurality of layout locations of the plurality of signal receiving lines, and the plurality of signal receiving lines are classified into the plurality of line groups according to the plurality of layout locations.

5. The noise canceling system of claim 1, wherein the layout design is related to a plurality of routing lengths between the plurality of signal receiving lines and the first touch display chip, and the plurality of signal receiving lines are classified into the plurality of line groups according to the plurality of routing lengths.

6. The noise canceling system of claim 1, wherein the first touch display chip is further configured to store a matching table, wherein the matching table is configured to store a correspondence between the layout design of the plurality of signal receiving lines and a configuration method for classifying the plurality of signal receiving lines into the plurality of line groups.

7. The noise canceling system of claim 1, further comprising a plurality of signal transmitting lines coupled to the first touch display chip and the plurality of signal receiving lines,
wherein the first touch display chip is configured to control a first portion of the plurality of signal receiving lines through the plurality of signal transmitting lines to generate the plurality of touch signals in a plurality of time periods.

8. The noise canceling system of claim 1, further comprising a second touch display chip,
wherein the first touch display chip is coupled to a first portion of the plurality of signal receiving lines,
wherein the second touch display chip is coupled to the plurality of noise canceling circuits and a second portion of the plurality of signal receiving lines, and configured to receive the plurality of touch signals and the plurality of noise canceling signals of the second portion, so as to generate the plurality of adjusted touch signals, and
wherein the first portion is different from the second portion.

9. The noise canceling system of claim 8, further comprising a plurality of signal transmitting lines coupled to the first touch display chip, the second touch display chip and the plurality of signal receiving lines,
wherein the first touch display chip is configured to control the first portion of the plurality of signal receiving lines through the plurality of signal transmitting lines to generate the plurality of touch signals in a plurality of time periods, and
wherein the second touch display chip is configured to control the second portion of the plurality of signal receiving lines through the plurality of signal transmitting lines to generate the plurality of touch signals in the plurality of time periods.

10. The noise canceling system of claim 9, wherein the first touch display chip and the second touch display chip are connected to each other, so as to synchronously control the plurality of signal receiving lines during the plurality of time periods.

11. A touch display device, comprising:
a touch display panel, comprising a plurality of touch units and a plurality of display units, wherein the plurality of touch units have a touch state, and the plurality of display units are configured to generate a display based on a display signal;
a plurality of signal receiving lines, configured to receive a plurality of touch signals from the touch display panel, wherein the plurality of signal receiving lines are classified into a plurality of line groups according to a layout design;
a plurality of noise canceling circuits, coupled to the plurality of line groups and respectively configured to generate a corresponding noise canceling signal based on the plurality of touch signals received by each of the plurality of line groups; and
a first touch display chip, configured to receive the plurality of touch signals and the plurality of corresponding noise canceling signals from each of the plurality of line groups, so as to generate a plurality of adjusted touch signals, wherein the number of the plurality of noise canceling circuits is greater than or equal to the number of the plurality of line groups.

12. The touch display device of claim 11, wherein each of the plurality of touch signals has a signal intensity,
wherein when the touch state of the plurality of touch units indicates that one of the plurality of touch units receives a touch operation, the signal intensity of a corresponding one of the plurality of touch signals is greater than the signal intensity of the other ones of the plurality of touch signals, and
wherein when the signal intensity of one of the plurality of touch signals is less than a trigger threshold, the one of the plurality of touch signals is configured to be a noise.

13. The touch display device of claim 12, wherein each of the plurality of noise canceling circuits is configured to calculate an average value of the signal intensities of the noises in a corresponding one of the plurality of line groups, and configured to generate the plurality of noise canceling signals based on the average value.

14. The touch display device of claim 11, wherein the layout design is related to a plurality of layout locations of the plurality of signal receiving lines, and the plurality of signal receiving lines are classified into the plurality of line groups according to the plurality of layout locations.

15. The touch display device of claim 11, wherein the layout design is related to a plurality of routing lengths between the plurality of signal receiving lines and the first touch display chip, and the plurality of signal receiving lines are classified into the plurality of line groups according to the plurality of routing lengths.

16. The touch display device of claim 11, wherein the first touch display chip is further configured to store a matching table, wherein the matching table is configured to store a correspondence between the layout design of the plurality of signal receiving lines and a configuration method for classifying the plurality of signal receiving lines into the plurality of line groups.

17. The touch display device of claim 11, further comprising a plurality of signal transmitting lines coupled to the first touch display chip and the plurality of signal receiving lines,
wherein the first touch display chip is configured to control a first portion of the plurality of signal receiving lines through the plurality of signal transmitting lines to generate the plurality of touch signals in a plurality of time periods.

18. The touch display device of claim 11, further comprising a second touch display chip,
wherein the first touch display chip is coupled to a first portion of the plurality of signal receiving lines,
wherein the second touch display chip is coupled to the plurality of noise canceling circuits and a second portion of the plurality of signal receiving lines, and configured to receive the plurality of touch signals and the plurality of noise canceling signals of the second portion, so as to generate the plurality of adjusted touch signals, and
wherein the first portion is different from the second portion.

19. The touch display device of claim 18, further comprising a plurality of signal transmitting lines coupled to the first touch display chip, the second touch display chip and the plurality of signal receiving lines,
wherein the first touch display chip is configured to control the first portion of the plurality of signal receiving lines through the plurality of signal transmitting lines to generate the plurality of touch signals in a plurality of time periods, and
wherein the second touch display chip is configured to control the second portion of the plurality of signal receiving lines through the plurality of signal transmitting lines to generate the plurality of touch signals in the plurality of time periods.

20. The touch display device of claim 19, wherein the first touch display chip and the second touch display chip are connected to each other, so as to synchronously control the plurality of signal receiving lines during the plurality of time periods.
